(19) United States
(12) Patent Application Publication
(10) Pub. No.: US 2002/0126628 A1
(43) Pub. Date: Sep. 12, 2002

(54) Peripheral having a wireless transmission apparatus

(76) Inventors: Bruno Fognini, Zurich (CH); Leonhard Fuesser, Zurich (CH); Beat Oberholzer, Seengen (CH); Edgar Schacher, Volkefswil (CH)

Correspondence Address: LERNER AND GREENBERG, P.A., Post Office Box 2480, Hollywood, FL, 33022-2480, US

(21) Appl. No.: 10/033,237

(22) Filed: Oct. 22, 2001

Related U.S. Application Data
(63) Continuation of application No. PCT/CH00/00083, filed on Feb. 14, 2000.

(30) Foreign Application Priority Data
Apr. 21, 1999 (CH) 0732/99

(51) Int. Cl. H04B 7/14

(52) U.S. Cl. 370/315; 370/465; 455/560

(57) ABSTRACT

A peripheral for connecting to a terminal via a first channel and for Tirelessly connecting to at least one partner appliance via a second channel. The peripheral includes a transmission/reception unit and an antenna connected to the transmission/reception unit for wirelessly connecting to the at least one partner appliance via the second channel. The peripheral also includes an interface unit for connecting the first channel and the second channel to the terminal.

### CROSS-REFERENCE TO RELATED APPLICATION

This application is a continuation of copending International Application No. PCT/CH00/00083 filed Feb, 14, 2000, which designated the United States.

### BACKGROUND OF THE INVENTION

Field of the Invention

The present invention relates to a peripheral for connecting to a terminal via a first channel and for wirelessly connecting to at least one partner appliance via a second channel. The peripheral includes a transmission/reception unit and an antenna for wirelessly connecting to the partner appliance via the second channel.

Equipping terminals, such as personal computers, with various peripherals and data network connection units for a public telecommunications network or for a local area network LAN requires a considerable amount of wiring complexity. First, this can impair the desired availability as a result of careless handling of such wiring. Secondly, the wiring cannot be brought up to the necessary state of the art in all buildings. Such wiring is often not possible because of economical, practical and esthetic reasons.

Such a wiring problem also arises with the increasing use of ISDN (Integrated Services Digital Networks) in private households: such use requires that an S-bus of four-wire design be routed in an apartment or in a house.

The technique of wireless coupling for a personal computer, for a FAX machine or for a telephone is one suitable solution in this case. DECT technology (Digital Enhanced Cordless Telecommunications) based on the ETSI (European Telecommunications standards Institute) standard EN 300 175 can be used to provide wireless communication both for voice and data services. U.S. Pat. No. 5,463,623 describes a wireless network allowing connection to a public telecommunications network (PSTN-Public Service Telecommunications Network, ISDN-Integrated Services Digital Network) and to a local area network (LAN). The reception/transmission station is in the form of an independent appliance to which terminals, such as a telephone, a personal computer or a fax machine, can be connected. Since this reception/transmission station requires no kind of control by the user in normal operation, it is often operated “invisibly” behind a desk or in a piece of furniture, for esthetic reasons. This entails considerable impairment of the transmission and reception conditions; thus, a drop in field strength or additional reflections have to be accepted, for example.

Rooms having a relatively large number of terminals may additionally be presented with the problem that the available frequency bands and the available bandwidth for the individual terminal runs short and are found to be disadvantageous for the user. U.S. Pat. No. 5,684,801 describes a method for virtually collision-free data transmission in a portable, wireless local area network. This solution also requires an additional external appliance (adapter) for a portable computer, such as a laptop. Carrying an additional appliance for the user can be regarded as a nuisance in terms of handling.

Wireless networking of personal computers using the product I-Gate® is likewise known (Siemens Schweiz AG I-Gate® Drahtloses PC-Netzwerk [Wireless PC network], March 1999). The use of the “Direct Sequence Spread Spectrum” (DSS) transmission method allows virtually collision-free data transmission to be achieved even in rooms having a relatively large number of such transmission apparatuses. A drawback is that each personal computer requires an additional external appliance which needs to be connected using a cable.

### SUMMARY OF THE INVENTION

It is accordingly an object of the invention to provide a peripheral which overcomes the above-mentioned disadvantages of the prior art apparatus of this general type. In particular, it is an object of the invention to provide a peripheral which permits wireless coupling of a terminal to a network, and which requires no additional external adapters and hence no additional cables and is easy to install.

With the foregoing and other objects in view there is provided, in accordance with the invention, a peripheral for connecting to a terminal via a first channel and for wirelessly connecting to at least one partner appliance via a second channel. The peripheral includes: a transmission/reception unit and an antenna connected to the transmission/reception unit for wirelessly connecting to the at least one partner appliance via the second channel; and an interface unit for connecting the first channel and the second channel to the terminal.

In accordance with an added feature of the invention, data is transmitted bidirectionally in the second channel using an ISM band of 2.4 GHz.

In accordance with an additional feature of the invention, the second channel is based on a protocol in accordance with standard IEEE 802.11.

In accordance with another feature of the invention, data are transmitted between the terminal and the peripheral in the first channel and the second channel by multiplexing using a given physical medium.

In accordance with a further feature of the invention, a transmission link is provided to route either the first channel or the second channel, between the peripheral and the terminal. The transmission link is a universal serial bus.

In accordance with a further added feature of the invention, the partner appliance is a terminal that is connected to another peripheral having another transmission/reception unit, an antenna connected to the other transmission/reception unit, and an interface unit.

In accordance with a further additional feature of the invention, the terminal is a data processing system.

In accordance with an added feature of the invention, the peripheral forms a part of a device selected from the group consisting of a printer, a mouse, a keyboard, a video camera, and a telephone receiver.

In accordance with yet an added feature of the invention, the peripheral is a telephone receiver that also includes an energy storage device. A voice link can be set up to the partner appliance using the first channel and also without using the first channel. The voice link can be set up when the data processing system is either in a switched on state or a switched off state.

In accordance with a concomitant feature of the invention, the peripheral includes control elements and display elements.

The inventive peripheral that has an incorporated transmission/reception unit provides the following advantages:

A terminal requires no additional adapter for coupling to a network; the functions of this adapter are contained in an associated peripheral, e.g. in a keyboard.

Wireless coupling of a terminal to a network can be achieved without additional wiring. The inventive peripheral is required for use of the terminal anyway.

Simple installation without touching the mechanics of the terminal to be coupled, since standardized interfaces are provided.

Since the peripheral is always required by a person in order to interact with, for example, a data processing system, the transmission/reception antenna that is contained in the peripheral is always in a good position with respect to the transmission/reception antenna of the cooperating partner, with which wireless communication proceeds.

Other features which are considered as characteristic for the invention are set forth in the appended claims.

Although the invention is illustrated and described herein as embodied in peripheral having a wireless transmission apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows an overview of the functional units;

FIG. 2a shows a block diagram of a keyboard having an incorporated transmission/reception unit;

FIG. 2b shows an illustration of a keyboard with the arrangement of a transmission/reception antenna; and

FIG. 3 shows a block diagram of a telephone receiver having an incorporated transmission/reception unit.

### DESCRIPTION OF THE PREFERRED EMBODIMENTS

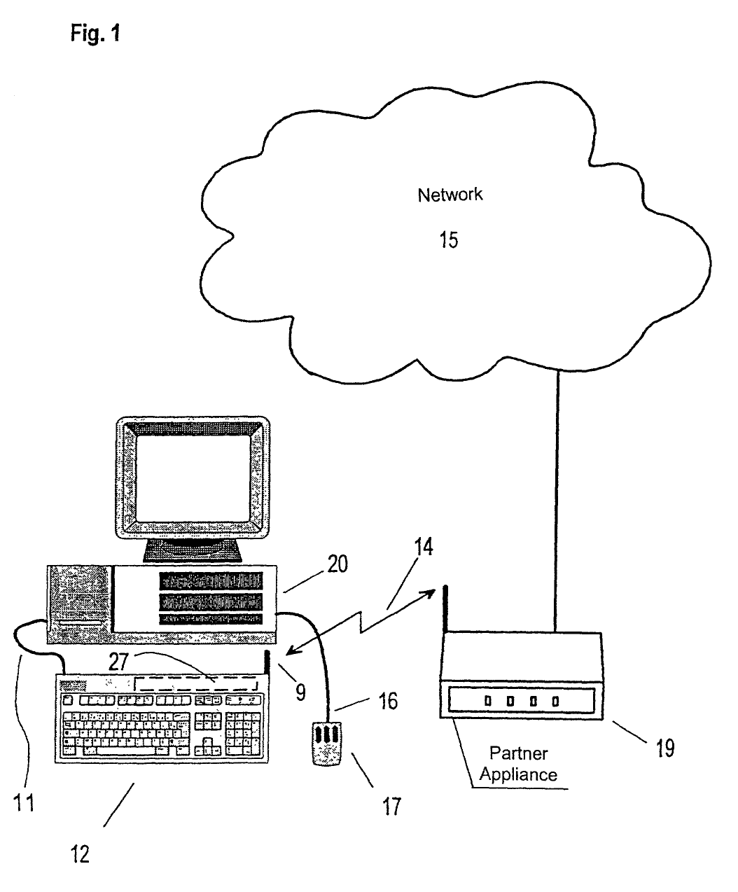

Referring now to the figures of the drawing in detail and first, particularly, to FIG. 1 thereof, there is shown a terminal provided in the form of a data processing system 20. The peripheral used is a keyboard 12 having an incorporated transmission/ reception unit 27. The keyboard 12 is connected to the data processing system 20 by means of a connection 11. The keyboard 12 has an antenna 9 which is used for making a wireless and bidirectional connection 14 to a partner appliance 19. A mouse 17 is likewise connected to the data processing system 20 by means of a line 16. The connection 11 is used for transferring data from and to the partner appliance and also for supplying the data entered by the keyboard. The partner appliance 19 is connected to a network 15.

The network 15 can be in the form of an LAN to which further terminals having the inventive peripheral are connected. Alternatively, it is possible for the partner appliance 19 to be connected to an ISDN network, to a PSTN network or to a cable network for TV and radio programs. Connection to a network in the form of the Internet is also possible, e.g. via a 2 Mbit/s link to an Internet service provider.

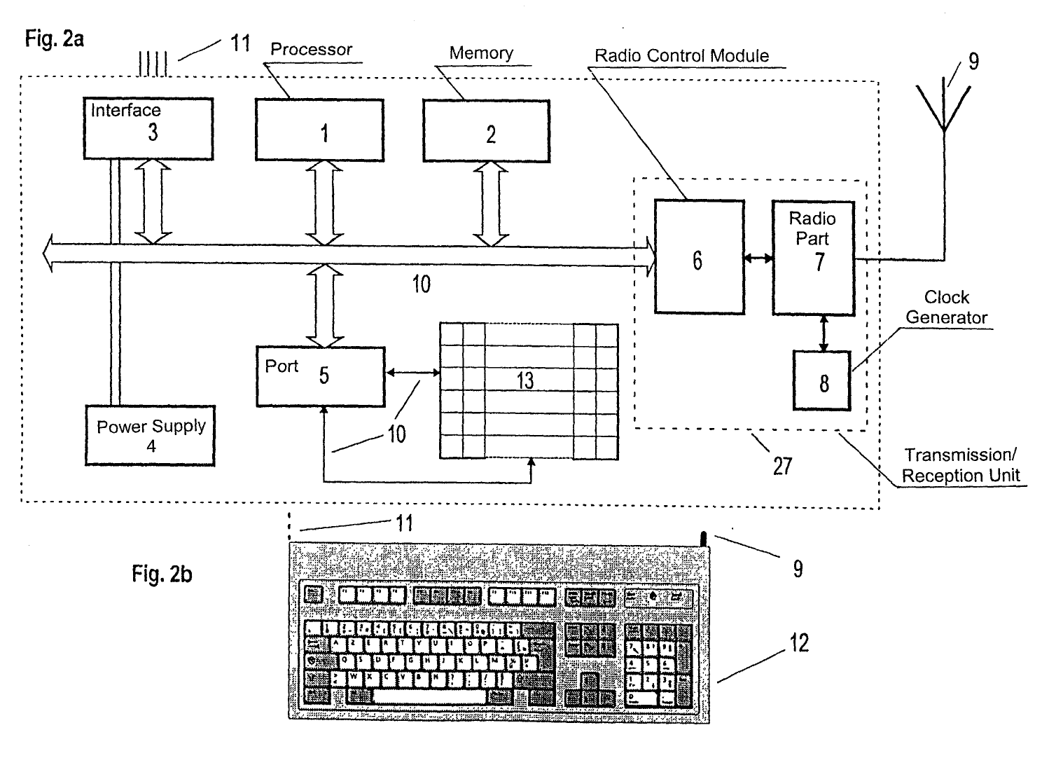

The block diagram shown in FIG. 2a is now used to explain the details of the inventive peripheral. The following units are connected to a bus 10: processor 1, memory unit 2, USB interface unit 3, radio control module 6 and port 5 for connecting the keys 13 of a keyboard. The memory unit 2 contains a read-only memory, e.g. flash PROM, and a volatile memory RAM. It is also possible for power to be supplied to RAM memory areas by “backup capacitors”, so that, in this way, a read-only memory is likewise formed. The transmission/reception unit 27 is formed by the radio control module 6, a radio part 7 and a clock generator 8. An antenna 9 is connected to the radio part 7. The radio part 7 derives the clock signal from the clock generator 8 (clock, crystal).

Transmission is based on IEEE's defined protocol published as in IEEE 802.11-1997 Wireless LAN Medium Access Control (MAC) and Physical Layer (PHY) Specifications, and this publication is incorporated by reference. The transmission itself is specified both for the infrared range and for radio transmission on the “ISM band” of 2.4 GHz. For the exemplary embodiment of the present invention, a spread spectrum technique is chosen for the “physical layer” (PHY); the standard mentions two transmission methods for this:

i) “Frequency-Hopping Spread Spectrum (FHSS) and

ii) “Direct Sequence Spread Spectrum” (DSSS).

The FHSS method permits a transmission rate of 1 Mbit/s, while the DSSS method permits transmission rates of 1 and 2 Mbit/s. The circuitry of the radio part can be produced using components from the manufacturer Harris Semiconductor, for example. A chipset with the product name PRISM® is available for this purpose. Details can be found in Harris Semiconductor Application Note October 1998, AN9820, A Condensed Review of Spread Spectrum Techniques for ISM Band Systems, which is incorporated by reference. The components mentioned have a “bus interface”. This interface allows the bus 10 to be connected to the radio control module 6. For communication with this chipset, the functional unit “Media Access 25 Controller HFA3840 MAC” or “HFA3841 MAC” is advantageously used and the associated configuration is stored in the read-only memory of the memory unit 2. Details relating to this functional unit can be found in Harris Semiconductor Description HFA3840, advanced draft Apr. 14, 1998, which is incorporated by reference.

For connecting the keyboard 12 provided with the transmission/reception unit 27 to a data processing system 20, a USB-type bus is used in one preferred embodiment. Keyboards very often incorporate processors of the 8051/8031 family from Intel®. The USB interface is therefore preferably equipped with a controller module of type 8x931AA or 8x931HA from the same manufacturer. The design of the interface can be found in Intel® 1996 USB Mobile System Design Guidelines and Harris Semiconductor Description HFA3840, advanced draft Apr. 14, 1998, which are both incorporated by reference. The USB-type bus has the following PIN assignment:

Pin 1: Vcc,

Pins 2, 3: data, and

Pin 4: ground.

The functions of the external adapter to be replaced in accordance with the invention are incorporated in the peripheral with the circuit and arrangement described above. A particular advantage is the use of the USB interface, since this “keyboard and adapter” peripheral now requires only configuration-related adjustments on the part of the data processing system. This is done, by way of example, by installing appropriate software modules such as drivers or library programs of the type DLL.

Alternatively, it is possible for the keyboard 12 to be connected 11 to the data processing system 20 in a conventional manner, e.g. using a connection to a COMx interface for the keyboard functions. A second connecting line is provided between the data processing system 20 and the transmission and reception unit 27 that is incorporated in the keyboard 12. This second connecting line can be routed directly to an LAN connection of the data processing system, for example.

FIG. 2b shows the arrangement of the antenna 9. At the selected frequency of 2.4 GHz, the wavelength is λ=0.125 m. A λ/2 or λ/4 rod antenna gives an antenna size which can also be incorporated fully within the keyboard or can be arranged in an entirely appropriate form on the basis of FIG. 2b.

The partner appliance 19 that is provided can be a data processing system 20 having the inventive peripheral. Alternatively, it is possible for the partner appliance 19 to have a transmission/reception apparatus 27 which is of essentially the same design as in the exemplary embodiment described above for the keyboard 12 and can be operated independently. In a further refinement of the “Media Access Controller HFA3840 MAC” or “HFA3841 MAC”, this partner appliance 19 can address a plurality of terminals at the same time, and a plurality of independent connections can be activated at the same time. This refinement of the “Media Access Controller HFA3840 MAC” or “HFA3841 MAC” can also be used in the exemplary embodiment of the keyboard 12.

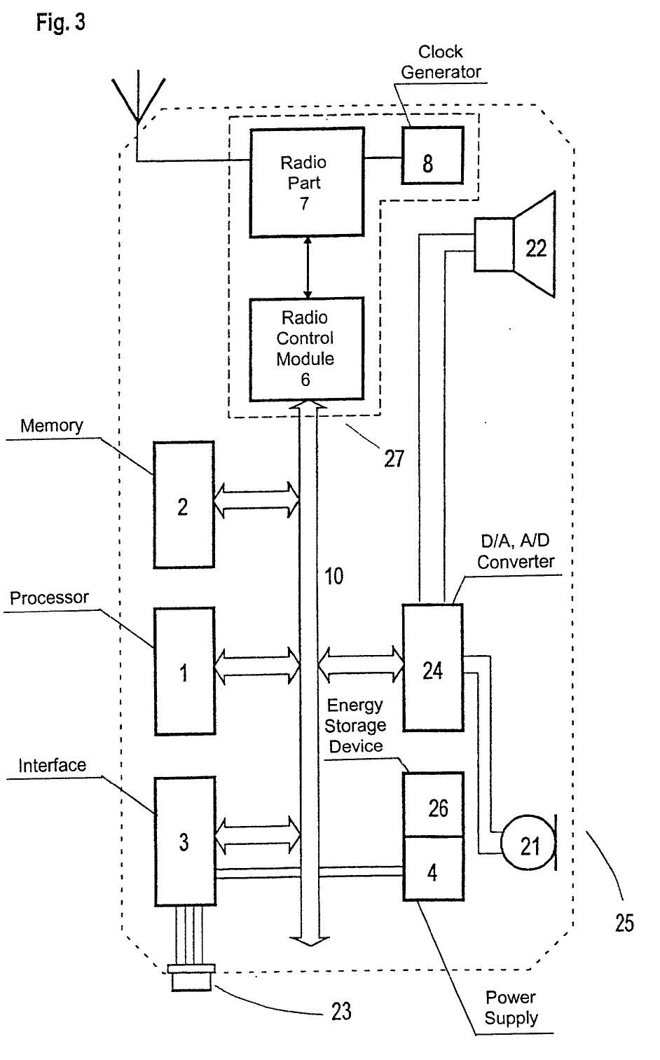

In another preferred embodiment of the present invention, the transmission/reception unit 27 is incorporated in a telephone receiver. The block diagram can be seen in FIG. 3. The circuit design requires the connection of an A/D and D/A converter 24 in order to route the digitally transmitted voice signals to the loudspeaker 22 as analog voice signals or to supply them from the microphone 21 to the A/D converter. For voice transmission, a “slow” subchannel of 1.5 Mbit/s transmission capacity is preferably provided on the USB link. For voice transmission in ISDN quality, just 64 kbit/s are sufficient in this case. The additional capacity up to 1.5 Mbit/s can be used to obtain better voice quality within a wireless network, for example, or to provide image transmission in addition to voice transmission.

Data processing systems are often switched off when they are not used over a foreseeable time. Switching on a data processing system often takes an inconveniently long time.

Depending on the processor power and the operating system used, the switching-on process can take several minutes. If the peripheral is a telephone receiver 25, this results in unacceptable waiting times until a mere telephone call can be made. For this reason, in another advantageous refinement of the invention, the telephone receiver 25 is additionally provided with an energy storage device 26 associated with the power supply unit 4, so that a call can be answered or transmitted via the radio link 14 even when the data processing system 20 is switched off.

The USB-type bus also permits the connected units to be supplied with electrical power. A power supply circuit 4 is connected to the USB interface unit 3. This circuit produces the other voltages required for supplying power to the individual components. The USB communication protocol can be used to instruct the data processing system 20 to regulate the power requirement supplied to the keyboard via the interface USB. Details can be found in U.S. Pat. No. 5,884,086, which is incorporated herein. Such regulation can advantageously be used for charging the energy storage device 26. A temporarily increased supply of electrical power can be used to charge the energy storage device 26 rapidly in a “fast charge procedure” so that a high level of autonomy is obtained for the telephone receiver 25 peripheral as soon as possible. Since the USB-type bus has only four lines, the connector 23 can be of simple design and can easily be incorporated into the housing of the telephone receiver 25.

The telephone receiver 25 can be equipped with control and/or display elements so that, even when the connection 11 is disconnected and/or isolated from the data processing system, calls can be made or messages received can be displayed or sent. For this purpose, a port 5 is advantageously connected to the bus (not shown in FIG. 3).

The position of the antenna is particularly significant. The inventive peripheral can also be in the form of a video camera for a data processing system. This is particularly advantageous because the video camera is usually positioned on or in the immediate vicinity of a screen, and this allows the radio link to a partner appliance to be easily brought into virtually direct visual contact.

The inventive peripheral can also be provided in the form of a mouse or in the form of a printer. The circuitry is preferably designed in a similar manner to that for the keyboard. The use of the USB interface is particularly advantageous because it is standardized for the data processing systems and is accordingly encountered frequently. The invention is not limited to being implemented using a USB interface, however; besides the aforementioned connection using PCMCIA slots, it is also possible to connect the inventive peripheral to parallel or serial interfaces of a data processing system, which are known to the person skilled in the art, by multiplexing the data.

Some or all of the functional units shown in FIG. 2a and FIG. 3 can be combined in a single electronic module ASIC. This can be implemented on the basis of, for example, the material disclosed in the document VLSITM—Technology wireless Communications—power and flexibility in a single chip, 1998, which is incorporated by reference.

We claim:

1. A peripheral for connecting to a terminal via a first channel and for wirelessly connecting to at least one partner appliance via a second channel, the peripheral comprising:
a transmission/reception unit and an antenna connected to said transmission/reception unit for wirelessly connecting to the at least one partner appliance via the second channel; and
an interface unit for connecting the first channel and the second channel to the terminal.

2. The peripheral according to claim 1, wherein data is transmitted bidirectionally in the second channel using an ISM band of 2.4 GHz.

3. The peripheral according to claim 1, wherein the second channel is based on a protocol in accordance with standard IEEE 802.11.

4. The peripheral according to claim 1, wherein data are transmitted between the terminal and the peripheral in the first channel and the second channel by multiplexing using a given physical medium.

5. The peripheral according to claim 1, comprising:
a transmission link routing a channel, selected from the group consisting of the first channel and the second channel, between the peripheral and the terminal;
said transmission link being a universal serial bus.

6. The peripheral according to claim 1, in combination with the partner appliance, wherein:
the partner appliance is a terminal that is connected to another peripheral having another transmission/reception unit, an antenna connected to said other transmission/reception unit, and an interface unit.

7. The peripheral according to claim 1, in combination with the terminal, wherein the terminal is a data processing system.

8. The peripheral according to claim 1, wherein said transmission/reception unit, said antenna, and said interface unit form parts of a device selected from the group consisting of a printer, a mouse, a keyboard, a video camera, and a telephone receiver.

9. A telephone receiver for connecting to a data processing system via a first channel and for wirelessly connecting to at least one partner appliance via a second channel, the telephone receiver comprising:
a transmission/reception unit and an antenna connected to said transmission/reception unit for wirelessly connecting to the at least one partner appliance via the second channel;
an interface unit for connecting the first channel and the second channel to the data processing system; and
an energy storage device;
a voice link can be set up to the partner appliance using the first channel and also without using the first channel; and
the voice link can be set up when the data processing system is in a state selected from the group consisting a switched on state and a switched off state.

10. The telephone receiver according to claim 9, comprising components selected from the group consisting of control elements and display elements.
